(19) United States
(12) Patent Application Publication
(10) Pub. No.: US 2008/0092047 A1
(43) Pub. Date: Apr. 17, 2008

(54) INTERACTIVE MULTIMEDIA SYSTEM AND METHOD FOR AUDIO DUBBING OF VIDEO

(75) Inventors: David N. Fealkoff, Thousand Oaks, CA (US); Jeffrey A. Dahlen, Pasadena, CA (US); Dan T. Pausback, Culver City, CA (US); Terry Wayne Sutherlin, Los Angeles, CA (US)

Correspondence Address: KLEINBERG & LERNER, LLP, 2049 CENTURY PARK EAST, SUITE 1080, LOS ANGELES, CA, 90067, US

(73) Assignee: RIDEO, INC., Thousand Oaks, CA (US)

(21) Appl. No.: 11/871,145

(22) Filed: Oct. 11, 2007

Related U.S. Application Data
(60) Provisional application No. 60/851,117, filed on Oct. 12, 2006.

(51) Int. Cl. G06F 15/173; G06F 3/048

(52) U.S. Cl. 715/716; 709/203

(57) ABSTRACT

An interactive multimedia system and method for audio dubbing of video is described whereby a number of participants may create new audio for a video clip. The video clip may be selected from among a group of pre-existing video clips. A director may act to determine the parameters of the audio recording process and one or more actors at remote locations from the director may record the audio portion to thereby create the new combined audio and video.

### CROSS-REFERENCE TO RELATED APPLICATIONS

The present invention claims priority on the basis of U.S. provisional patent application with Ser. No. 60/851,117 filed Oct. 12, 2006 and entitled Interactive Multimedia Game for Audio Dubbing of Video which is incorporated herein in its entirety by reference.

### BACKGROUND

1. Field of the Invention

The present invention relates to audio and video content and more particularly to an interactive multimedia game including audio dubbing of video.

2. Description of the Related Art

In the prior art there are various means for recording audio and video content. There exist numerous types of video recording apparatus from video cassette recorders to video cameras. More modernly, video may be recorded digitally and transmitted or placed on computers. Many modern video television programs and motion pictures are captured using high-quality digital cameras.

Digital video provides numerous opportunities for use of the video in conjunction with computers capable of processing the video. Many modern computer software programs enable individuals to edit, cut, splice, create transitions and otherwise create high-quality videos on individual personal computers.

High-speed local networks and the growing use of high-speed internet bandwidth allow individuals to share information, including digital video, on an unprecedented scale. Internet users can share information using web logs (“blogs”), internet forums, email, instant messaging, web pages, videos, web-casts and social networking websites. Many of these medium of sharing information provide only or largely one-way interaction. Users yearn for the opportunity to take part in group activities or to share experiences with users in real-time.

The desire to share experiences has led to a rise in the popularity of social networking websites. These are websites dedicated to allowing users to connect one with another. These sites allow users to view and create profiles, to search for friends, to schedule events and make comments about each other. These sites have generally provided limited means by which users may interact with one another in real-time.

Video sharing websites are also known in the art. These sites have become repositories of online videos. Users may upload videos for viewing by the public. Other viewers may view the videos and, if desired, comment upon the videos. The videos vary from home videos to television programs created by users. While video is an excellent medium for expression, the uploaded videos remain substantially a one-way communication and interaction process. Not created in an online collaborative environment by multiple individuals simultaneously.

Also in the prior art, communication has been enabled via voice over internet protocol (“VoIP”) communications. VoIP communications allow individuals to use internet transmissions of data to communicate audio and, in some cases, video as well. However, no easy method of utilizing a pre-existing video and the internet to create audio for an existing video clip collaboratively has as of yet been devised.

Finally, the prior art includes online multiplayer games in which groups may take part and create scenarios in which they perform quests for various real and imaginary rewards. These games do not, generally, provide means for creating video content from this process. Similarly, they do not provide means by which users can share the experience or content created with other individuals on any large scale.

For these reasons, there exists in the prior art a need to provide a novel means by which multiple individuals may interact to thereby create video content. There exists a need to share content created collaboratively using this method. There further exists a need to provide means by which feedback, comments, thoughts and additional creation based upon the collaboratively created content may be facilitated. There also exists a need for a system capable of providing a robust mechanism whereby collaborative audio dubbing as a means of creating content may take place.

### SUMMARY OF THE INVENTION

The invention provides a means by which users may create video which is collaboratively dubbed by multiple individuals simultaneously. Specifically, the present invention is an interactive multimedia system and process for audio dubbing of video. The present invention is intended to enable creativity, particularly of an improvisational form. The preferred embodiment of the present invention provides numerous benefits over the prior art.

In its most basic form, the present invention provides a means by which users may view and select video for which to create new “dubbed” audio. The present invention then allows users to collaboratively, using the internet, create audio for the video and to share the combined audio and video with the general public or with a specific group. The general public or the group with whom the new content is shared may then comment on the combined audio and video, rate the combined audio and video or make a new combined audio and video based upon the video selection. The present invention allows users create profiles, which include audition materials, as a means to be requested to participate in the creation of a combined audio and video.

The present invention overcomes the limitations of the prior art and provides several benefits not known in the prior art. The present invention provides means by which individuals may collaboratively create audio dubbing for video. The present invention allows users to utilize pre-existing video or, in some embodiments, to submit their own video to take part in the dubbing process. The present invention also allows users to easily share, rate and comment upon videos, while simultaneously allowing individuals to organize into social groups, as they see fit, within the confines of the invention. The present invention also allows users to partake in social events via the web.

It is therefore an object of the present invention to provide means by which users may take part in collaborative audio dubbing of video. It is a further object of the present invention to provide means by which the audio may be dubbed by one or multiple individuals in several locations. It is a further object of the present invention to provide a means by which the video for which audio will be dubbed may be selected from among a library of possible videos.

It is a further object to provide the capability to perform post processing of video, such as adding sound effects and other special effects to a created video. It is a further object to provide means by which a director may control the process including selecting a clip, auditioning individuals, scheduling the production and completing recording and post-processing all within the confines of a single simple-to-use software application.

It is yet another object of the present invention to provide means by which individuals can upload, share, view comment upon and rate the combined audio and video created content using the method and apparatus of the present invention. It is a further object of the present invention to provide means by which individuals may interact while creating the dubbed video. It is yet another object to allow users to easily create content by providing as much direction to the users as possible before the recording process begins in the form of a storyboard made up of various metadata associated with a particular clip.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is an overview of the elements that make up the system of the present invention.

FIG. 2 is a detailed view of several components making up the elements of the system of the present invention.

FIG. 3 is a flowchart of the steps involved in the creation of a new production in the present invention.

FIG. 4 is a flowchart of the steps involved in an audio dubbing or recording session.

FIG. 5 is an example first screen of the client application used in the present invention.

FIG. 6 is an example of the one of director's client application pages used in selecting a video for which audio will be created in the present invention.

FIG. 7 is an example of another of the director's client application pages associated with the process of audio creation for a video in the present invention.

FIG. 8 is an example of the actor's client interface and a messaging window used in the process of creating audio for a video in the present invention.

FIG. 9 is an example timeline (cueing system) of audio sounds into which one or more users may create audio for a video.

### DETAILED DESCRIPTION OF THE INVENTION

Throughout the specification, claims and abstract, the term “video,” unless otherwise indicated by context, is intended to mean a video file resident on one or more computers using a codec suitable for transmission via a network, such as the internet. The term “video” unless clearly indicated otherwise, is intended to represent a video file that either does not contain a current audio track or a video file for which the audio track may be rewritten through the process described herein.

The term “audio” as used herein is intended to mean one or more audio files recorded or resident on one or more computers. Audio is also intended to indicate an audio file which is or will be encoded or “dubbed” into or along with a video, as described above. Audio may be representative of a single file or a group of files, from numerous sources including files stored on an individual computer, stored on a server or files created in real-time while viewing a video.

The terms “dub,” “dubbing,” “dubbing process,” “audio dubbing session,” “content creation,” “event,” “process,” “production”, “recording session” or “game” are intended to indicate the overarching process, as described herein, whereby one or more actors take part in the process of adding a new audio track to or “dubbing” of a video by one or more users at the same or remote locations from one another simultaneously.

The terms “combined audio and video,” “dubbed video” “created video,” “completed video,” “created content,” “content” or “collaborative video” are intended to mean the combined audio and video created using the process of the present invention described herein. These terms are intended to indicate, interchangeably, the combined audio and video results of adding one or more new audio tracks to a pre-existing or created video file.

The term “production” refers to the combination of video and metadata or storyboard that is used as the basis for any subsequent dubbing. The term “production” defines dubbing session which is to take place. It is analogous to a movie production where script and actors may have been chosen but shooting has not yet occurred.

It is further to be understood that the terms “actor” and “director” herein both refer to one user of the site. The term “actor” refers to a user in the form of an individual providing audio talent through voice, impressions, singing and sound effects to a particular game. The term “director” may refer to one or more actors taking part in a game. However, the director is the individual, actor or not, who is orchestrating the process of the creation of a new audio and video combination and is creator/owner of the production.

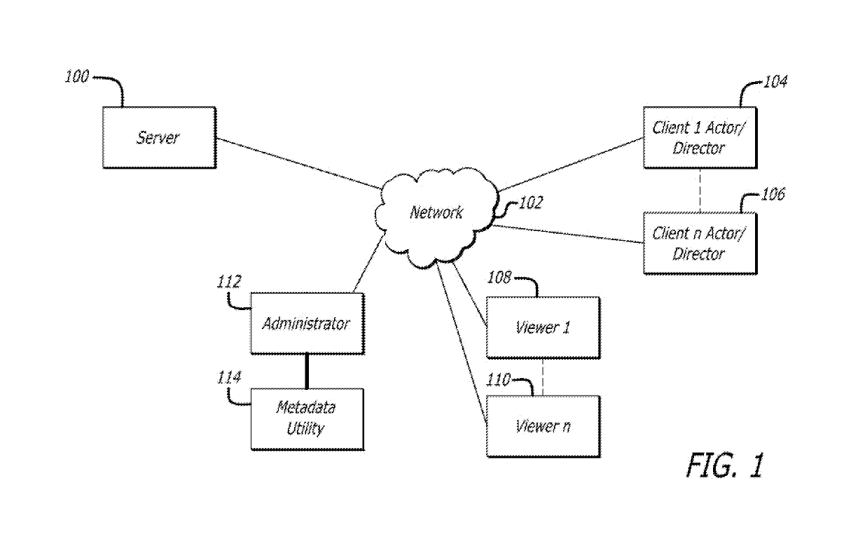

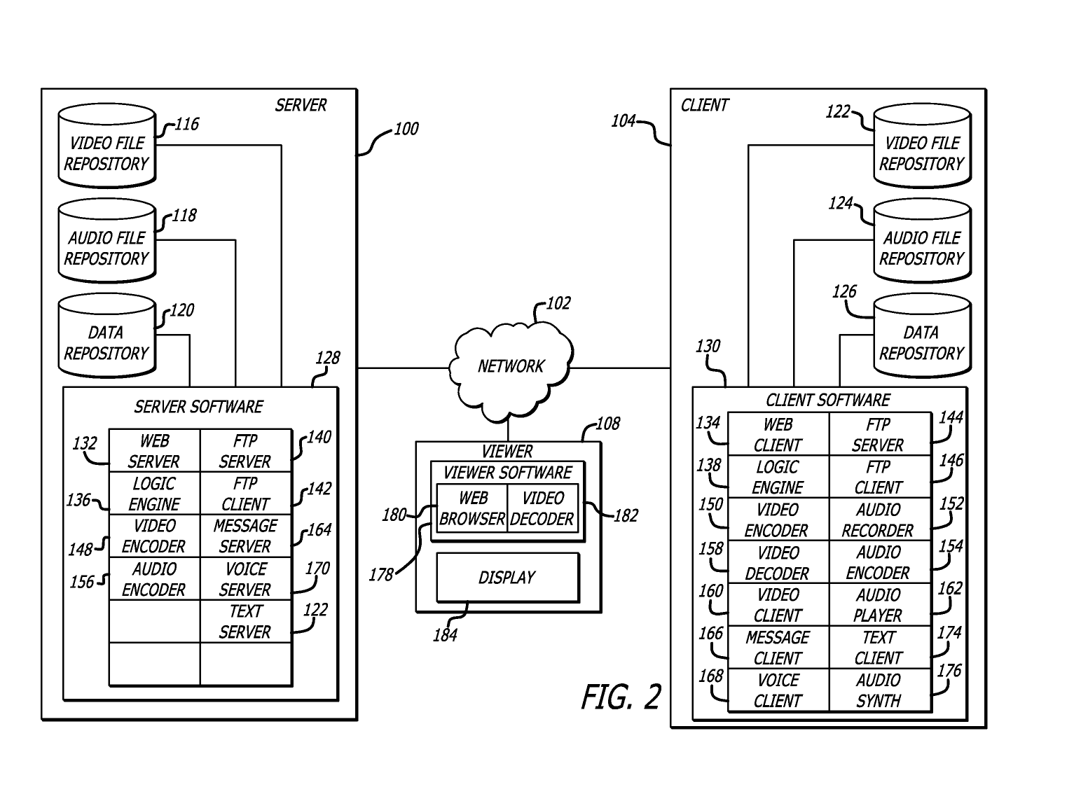

Turning first to FIG. 1, an overview of the elements which make up the system of the present invention are shown. The server 100 is a computer or computers with access to a network 102. The server 100 may in fact be a group of servers or a single server 100. The server 100 is responsible for orchestrating the audio dubbing process. The server 100 handles video files, audio file synchronization with the video, the serving of web pages, the serving of communications of various types amongst the participants and various other processes. The server is described in greater detail with reference to FIG. 2.

The network 102, which may take the form of a local network, a private network (or virtual private network) or the internet, is capable of handling communications of various types between the client 104, the server 100, the viewer 108, the administrator 112, and the metadata utility 114. The network is designed in such a way that it is capable of transmitting audio and video files amongst the participants in the process of the present invention.

In particular, the network 102 is capable of sufficient speed that it may suitably transmit and receive video files in order to carry out the functionality of the present invention. Modern video files use various codecs (methods of encoding and decoding audio and video) such that video (or combined audio and video) may be transmitted over the internet. Audio files utilize similar codecs in order to compress files for transmission. Typically, compression or other forms of shrinking audio or video files are used to create files that may be transmitted more easily over a network.

The client 104 is a computer used by an actor or director of the audio dubbing session. This is a computer at a remote location from that of the server 100, connected by the network 102 to the server 100. The process of this invention can include any number of clients from client 104 to client n 106. These clients take on the role of actors or a director. In a given game, one person may be a director and may simultaneously record his or her voice as well. In the preferred embodiment, the director generally acts in one of the roles.

The user of client 104 is an actor in the sense that each client may take part in the dubbing process by which new audio is added to a preexisting or created video. Dependant upon the number of “roles” available in a given video, the number of clients may vary from one up to virtually any number. For practical or technical reasons, in some embodiments, the number of simultaneously connected clients 104 may be limited.

The user of client 104 may be a director in the sense that, using the software and process described herein, the user of client 104 may organize and orchestrate the game. The user of client 104 as director may select the date and time of recording, may select during which time periods individuals are speaking in a given game or the parts particular actors may play.

The user of client 104 may also determine when a combined audio and video is complete in the role of director. The user client 104 may make a number of role-defining choices when the user of client 104 acts as the director. A user of client 104 may also as director, simultaneously, act within one or more given roles. The client 104 will be described in greater detail with reference to FIG. 2.

The next element in this overarching structure is the viewer 108. The viewer 108 is a computer or computers that may be used to watch the combined audio and video created by the process described herein. The viewer 108 and client 104 are shown in FIG. 1 as if they are separate from one another. However, it is to be understood that any one of the clients 104 may also, simultaneously or at a later time, be a viewer 108.

There exist numerous viewers from viewer 108 to viewer n 110. These are intended to indicate that a large number of individuals may view the combined audio and video created by the process of this invention using this system. The viewers may search for completed audio and video combinations, receive hypertext markup language (“HTML”) links to completed videos or may browse one or more websites hosted in whole or in part by the server 100 to find completed videos, as well as utilize other services provided by the server.

Many viewers 108 may perform these search functions simultaneously. Many viewers 108 may also view completed videos, download completed videos, comment upon completed videos, view storyboard data, view profiles of directors and actors and otherwise share or interact with completed videos and associated content hosted on the server 100 or a remote storage location to which the server 100 has access. The viewers 108 and the actions and processes which they may access are discussed in additional detail with reference to the remaining Figures.

Finally, the administrator 112 is a computer or computers associated with one or more individuals who access and control the server 100 or software utilities used to manage the server 100 or the content in it, such as the Metadata Utility 114. In the preferred embodiment, the administrator 112 has access to and uses the metadata utility 114 to add metadata or a “storyboard” to a given video clip. The metadata utility 114 is used in the preferred embodiment by the administrator 112 to input storyboard data pertaining to a video clip for which audio will be created.

In the preferred embodiment, the metadata utility 114 is a software application. The metadata utility 114 is used by the administrator 112, primarily, to generate scene information including “premise” and “traits” and “objectives” for each role of a given combined audio and video. These “traits” and “objectives” help to enable creativity in the creation of the content in the absence of any actor or director-created “storyboard”. In alternative embodiments, the director or the actors may have access to and the ability to edit the “premise”, “traits” and “objectives” using the metadata utility 114, though in the preferred embodiment, these capabilities are provided to the administrator 112 only.

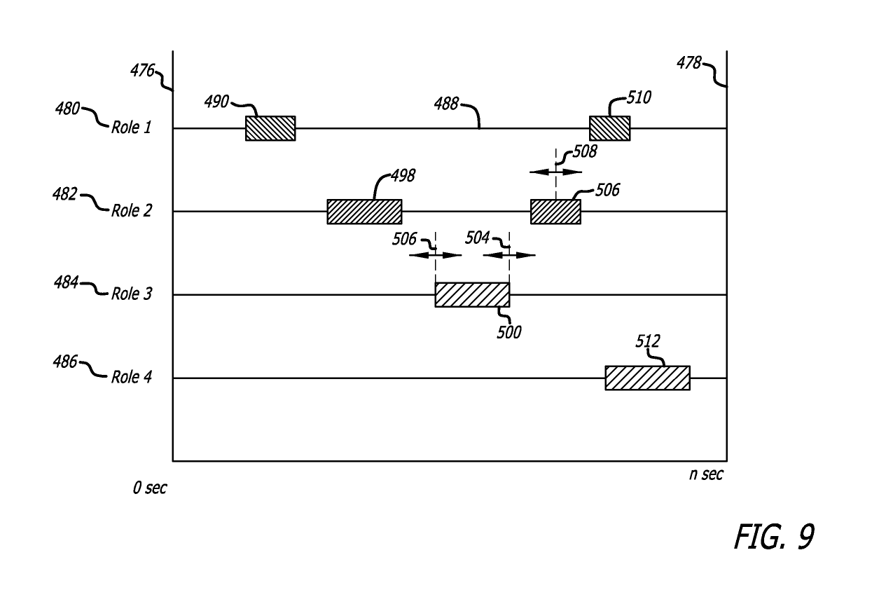

The metadata utility 114 is also used to create the timeline of each role. An example timeline for each role is shown in FIG. 9. The timeline is not actually created as an image, instead it is database data including the start and stop time of the clip for which audio is to be created and the start and stop time of each speaking role within the clip. It further includes additional data pertaining to a clip for which audio will be created as described above.

Turning now to FIG. 2, a more detailed depiction of the system of the present invention is shown. The server 100, the client 104 and the viewer 108 are shown, each connected to the network 102. As described above, in the preferred embodiment the network 102 is the internet. It alternative embodiments, it may, instead, be a local network.

The server 100 is responsible for orchestrating the creation of the combined audio and video that are the result of the process described herein. In order to complete this process, the server 100 is made up of many elements. It is to be expressly understood that the server 100 is not necessarily and, in fact, in actual reduction to practice is not, a single physical server 100. Instead, the server may be made up of multiple physical servers with various forms of single or multi-function server software running upon them.

The server 100 is made up of several components. Each component may be resident on one or more physical servers. The components are software programs which perform one or more functions. For example, one component may be both a web server and a video encoder. Alternatively, one component may be a message, voice and text server simultaneously. Alternatively, each component may be an individual, interconnected piece of software. In yet another alternative, each of the components may be a piece of a single integrated software.

The video file repository 116 is a place in which video files are stored. This repository 116 may include completed videos or video that may be used to create completed videos. It is to be understood that the repository 116 may be storage local to the server, such as a hard disk drive or other form of local storage. Alternatively, the repository 116 may be at a remote location, such as a high-bandwidth, high accessibility server or server group designed for the storage of multimedia content. The repository 116 and video stored thereon is readily accessible to the other functionality of the server 100.

The audio file repository 118 is the server-accessible storage location for audio files uploaded by clients, such as client 104. The audio file repository 118, as with the video file repository 116, may be local to the server 100 or may be a remote server group including large-scale, multimedia file storage and access to which the server 100 has access. In the preferred embodiment, the audio file repository is remote from the server 100.

Finally, the data repository 120 serves the same function as the video file repository 116 and the audio file repository 118 for the server 100 with regard to data. The type of data the data repository 120 holds is, for example, metadata, scheduling data, and user profile data related to the creation of the combined audio and video. The data repository 120 also retains data related to the users who participate in the creation of a combined audio and video or to take part in a game or registered users who do not.

The client 104 also has access to its own video file repository 122, audio file repository 124 and data repository 126. The functions of these elements are similar to those for the server 100. The client 104 repositories 122, 124 and 126 provide access to the client 104 to video, audio and data, respectively. These repositories 122, 124 and 126 may be local or remote, as described above.

In the preferred embodiment, the client repositories 122, 124 and 126 are temporary storage locations for temporary storage of video files for which audio is being created and audio files which are being added to the video file. These temporary storage locations are in folders and files resident on the client 104 hard disk drive. In alternative embodiments, the repositories 122, 124 and 126 may be remote locations, such as high-volume repositories of multimedia data. Alternatively, the repositories 122, 124 and 126 may be repositories at other locations on the internet in which videos made or accessible by the client 104 are placed, for example, other videos accessible on the internet, which have been uploaded to a video sharing site or to a user's web host.

The server software 128 is shown including several components which make up this software 128. The client software 130 is also shown as a portion of the client 104. The first piece of server software 128 is the web server 132. As is well-known in the art, the web server 132 interacts with one or more web clients 134, such as the web client 134 which is a part of the client software 130.

The web server 132 may be a web server capable of delivering any number of hypertext markup language documents to a web client 134. In alternative embodiments of the present invention, however, the web server 132 may include the capability of providing Java® applets, Flash® animations and videos, real-time audio and video streaming or media content of various formats and providing an interface through which client-to-client voice and text-based chat may occur. The web server 132 may also include the capability to send and receive email.

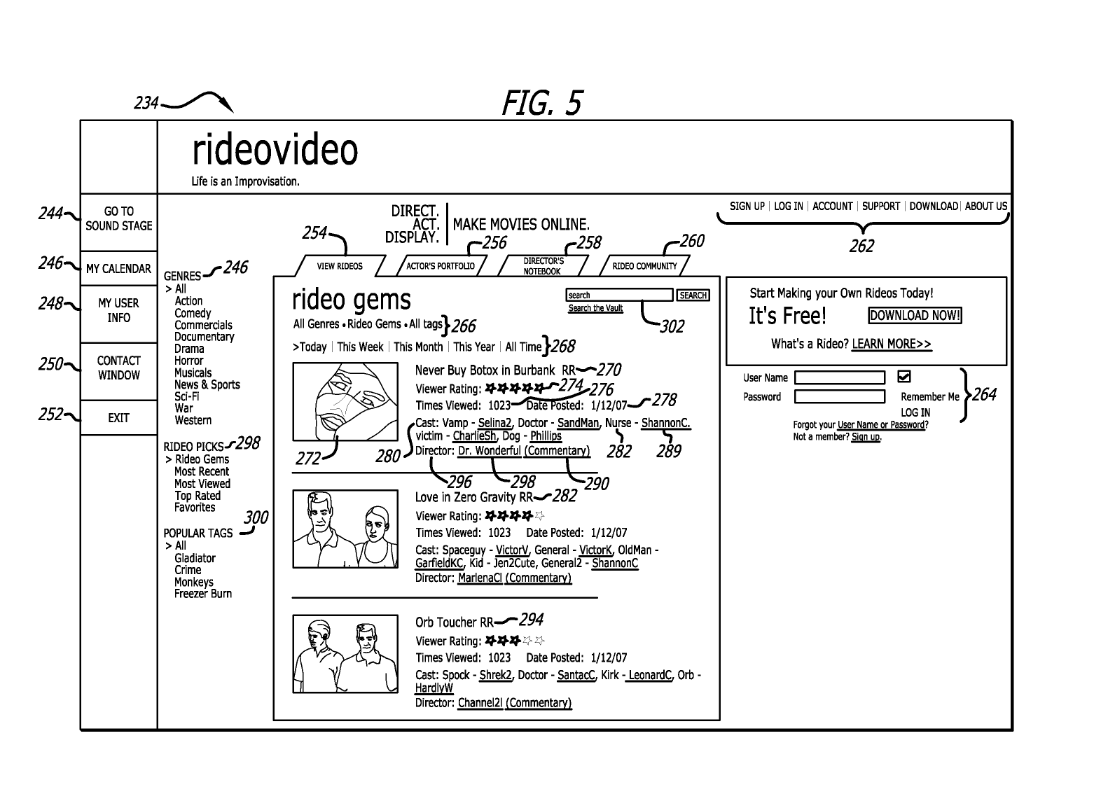

The web client 134 may be a web browser. In the preferred embodiment, the web client 134 is a web browser software application integrated into the client software 130. An example of this web client 134 may be seen in FIG. 5. However, in alternative embodiments the web client 132 may also include the capability to run Java® applets (such as a Java® virtual machine), the capability to run Flash® animations and videos and to provide various other types of functionality to a user of the client software 130.

The client software 130 may also take the form of an application running within a web browser in alternative embodiments. However, in the preferred embodiment, it is part of a downloadable stand-alone application capable of many or all of the functions described herein. The client software 130 may include more than one web client 134. In the most general terms, the web server 132 and the web client 134 are two software programs capable of interacting with one another to carry out some of the processes of the present invention.

The next component of server software 128 is the logic engine 136. The logic engine 136 has its client-side counterpart in the logic engine 138. In both the server software 128 and the client software 130, the logic engine 136 and the logic engine 138 include all logic which is used to operate each of the components of the server 100 and the client 104 and to control the interaction of the various components within the server 100 and the client 104, respectively.

For example, the logic engine 136 receives messages from the web server 132 and instructs it to react to a web client 134 in a particular way in response. Simultaneously, the logic engine 138 controls reactions of and the interaction between elements within the client software 130. The logic engine 136 coordinates interactions within the sever software 128 and with the client software 130.

The logic engine 136 includes logic responsible for managing the storage, retrieval and archiving of audio, video and data files, managing the interactions of client software 130, directing the encoding of video and audio files. Virtually all of this logic directs one or more of the components listed herein to perform the selected task.

Similarly, the logic engine 138 is responsible for managing the interaction of the client 104. The logic engine 138 manages the creation of audio tracks, the encoding and uploading of audio, the downloading of video for viewing, the downloading and processing of video and metadata for use in preparing new audio tracks for video files. The logic engine 138 operates in conjunction with many of the components resident on the client 104 and within the client software 130.

The logic engine 136 and logic engine 138 include all programming logic required for interaction of the various components making up the system of the present invention. It is to be understood that where processes or methodologies are described, they are generally executed through the workings of either the logic engine 136 or the logic engine 138 or both, generally in conjunction with one or more of the components making up the server 100 and the client 104.

Hypertext transfer protocol (“HTTP”) is often used in the preferred embodiment as the means by which files are uploaded from the client 104 to the server 100 or other clients and the means by which files are downloaded from the server 100 to the client 104. The FTP server 140, FTP server 144, FTP client 142 and FTP client 146 are the next elements in the server software 128 and client software 130. The FTP server 140 and FTP server 144 are used to receive files from the client 104 and server 100, respectively. In alternative embodiments, various other transfer protocols such as file transfer protocol (“FTP”), peer-to-peer (“P2P”) related protocols or other web file-transfer protocols may also be used.

In the preferred embodiment of the present invention, audio is recorded at several remote client computers, such as client 104 using the client software 130. The audio must then be transmitted to the client software 130 which is currently acting as the director so that it may be added to the video file for which audio tracks are being created. This process is accomplished, in the preferred embodiment, by means of the FTP client 146 for each client software 130 transmitting files at the request of another client software 130 at a location remote from the first.

Correspondingly, any data which must be transmitted to the client 104, such as the video file for which audio is being recorded, is requested by the web client 134, and sent by the web server 132 to each client 104. Generally, the data is transmitted back and forth from server 100 to client 104 by means of the network 102 using HTTP protocols. As described above, other protocols such as FTP or P2P protocols may be used as the preferred transmission protocol for some data or in other embodiments.

The video encoder 148 is used by the server 100 at the command of the logic engine 136 to create a combined audio and video production using the audio created by each of the client computers, such as client 104, and the video for which the new audio tracks are being created. The result is a video file with one or more new audio tracks or dubs added to the file. The video encoder 148 is used to create the new video.

The video encoder 148 may take many forms. In the preferred embodiment, the video encoder 148 encodes the audio and video into a form suitable for embedding within a webpage for ease of viewing and transmission. One suitable format is Flash® video, high-compression video format that is excellent for use in “streaming” and “embedding” the video in web pages.

In alternative embodiments, the video encoder 148 may use any number of video forms. Various forms of video may include windows media video (WMV), DIVX, AVI, MPEG, MPG, Mpeg-2, Mpeg-3 or Mpeg-4 video. Virtually any type of codec may be used or created by the system of the present invention for audio or video.

Next, the video encoder 150, audio recorder 152 and audio encoder 154 are also a portion of the client software 130. The video encoder 150 may be used by a client software 130, acting in director mode, to create the combined audio and video. The client software 130 performs this task in the preferred embodiment because video and audio encoding is a processor-intensive task which is best performed locally. The client software 130 retains this capability and takes advantage of the capabilities of the client 104 to perform this task rather than taxing a central server 100 with many requests to encode video.

The audio recorder 152 and audio encoder 154 are portions of the client software 130 used to create audio at each client 104. As audio is created, each of the audio creations may be delivered to the director's client software 130, via FTP or other protocol and subsequently, using the video encoder 150, be added to the final combined audio and video.

The audio encoder 156 on the server 100 may be used in conjunction with the video encoder 148 to create a combined audio and video file in some embodiments. In the preferred embodiment, a client software 130 acting as a director combines each of the audio file creations to create the new combined audio and video file. However, the server software 128 may simultaneously or at a later time use the video clip and received audio files to create a higher-quality combined audio and video, using the original video and audio.

Similarly, the video decoder 158 and video client 160 may be used to display the video for which audio is being created. In the preferred embodiment, the video decoder 158 is used in conjunction with the video client 160 to play a desired video clip for which audio is being created, both at a client 104 acting as a director and at a client 104 acting as an actor. This process is described in greater detail below. In the preferred embodiment, the video client 160 often includes combined video and audio decoding capabilities so that a client can playback combined video and audio.

The audio player 162 may be used to play audio of various formats and compressions. In the preferred embodiment, the audio player is capable of playing various formats. The audio player 162 may be used by client software 130 to play back audio which has already been recorded.

The message server 164 is a portion of the server software 128 used to provide updates to one or more of the client software 130 applications running on one or more clients, such as the client 104. The message client 166 in the preferred embodiment is the means by which each client software 130 communicates with the server software 128 and with other client software 130.

The client software 130 and server software 128 of the present invention communicate and interact using instructions, sent in the form of messages from client software 130 to client software 130 or to and from the server software 128 or with the aid of the server software 128 (as in peer-to-peer) to other client software 130. The message server 164 of the server software 128 and the message client 166 of the client software 130 coordinate and receive these communications, generally providing them to the logic engine 136 and 138 for further instructions.

The voice client 168 and voice server 170 may provide additional communication functionality to the users of the present system. The voice server 170 provides voice over internet protocol (“VoIP”) communications to each of the clients, such as client 104. The corresponding client software 130 is the voice client 168. The voice client 168 allows each of the users to communicate with one another in real-time, or substantially real-time, using voice over internet protocol.

The text server 172 and text client 174 act in a way very similar to that of instant messaging, as it is known in the art. The text client 174 allows a user to input text at a client location. In one embodiment the text is received by the text server 172 and forwarded on to one or more other text clients 174 are different client locations. Transmission of the message may also utilize a peer-to-peer structure where messages are sent directly from client 130 to client 130. As has been explained above, a multiplicity of clients 104 may be connected to the server 100 at one time. In some cases, the viewer 108 may have access to text created by the text client 174 or received by the text server 172. In some embodiments, the text client 174 may be capable of communicating directly with a text client 174 in another client 104.

Finally, the client software 130 includes a audio synthesizer 176. This component may be used to allow type-written text to be transformed into audio for use in a video file. A user may not have a microphone, but may wish to take part in the process. This user may utilize the audio synthesizer 176 to create a voice or other sound based upon typewritten text. The user may select from a variety of voices or sounds in order to create the speech for use with the combined audio and video. Additionally, the audio synthesizer may be used to allow users to morph their voices creating variants of their own voice, like the chipmunks or Darth-Vader.

The viewer 108 is yet another computer, though a viewer 108 may also be a client 104, that includes viewer software 178 suitable for use in viewing the combined audio and video. The viewer software 178 includes a web browser 180 for viewing content sent by the web server 132 and a video decoder 182 and video client 160 so that it may view the created videos. In the preferred embodiment, the video decoder 182 is capable of decoding the type of video used to store the combined audio and video files or video files without combined audio or other media files created using this method.

The viewer 108 also includes a display 184. The display 184 is a computer monitor, television, projection device or other means for viewing combined audio and video content. In some embodiments, the viewer 108 may instead be a portable device, such as a personal digital assistant, smartphone or other similar device. In these cases a web browser 180 may or may not be provided, and the display 184 may instead be a small-scale screen or other small-scale audio-visual reproduction device.

The workings of the present system may be better understood by a discussion of the method of the present invention. The present invention is generally used by a group of individuals who wish to over-dub audio onto a pre-existing or previously-created video. The users, each of which are represented by a client 104 (see FIG. 2) using client software 130, login to a server 100 (see FIG. 2) using server software 128 in order to take part in this process. The server 100 coordinates the process, at the direction of one or more users, enables the creation of the video, enables the combination of the created audio with a video clip, then stores the created audio and video.

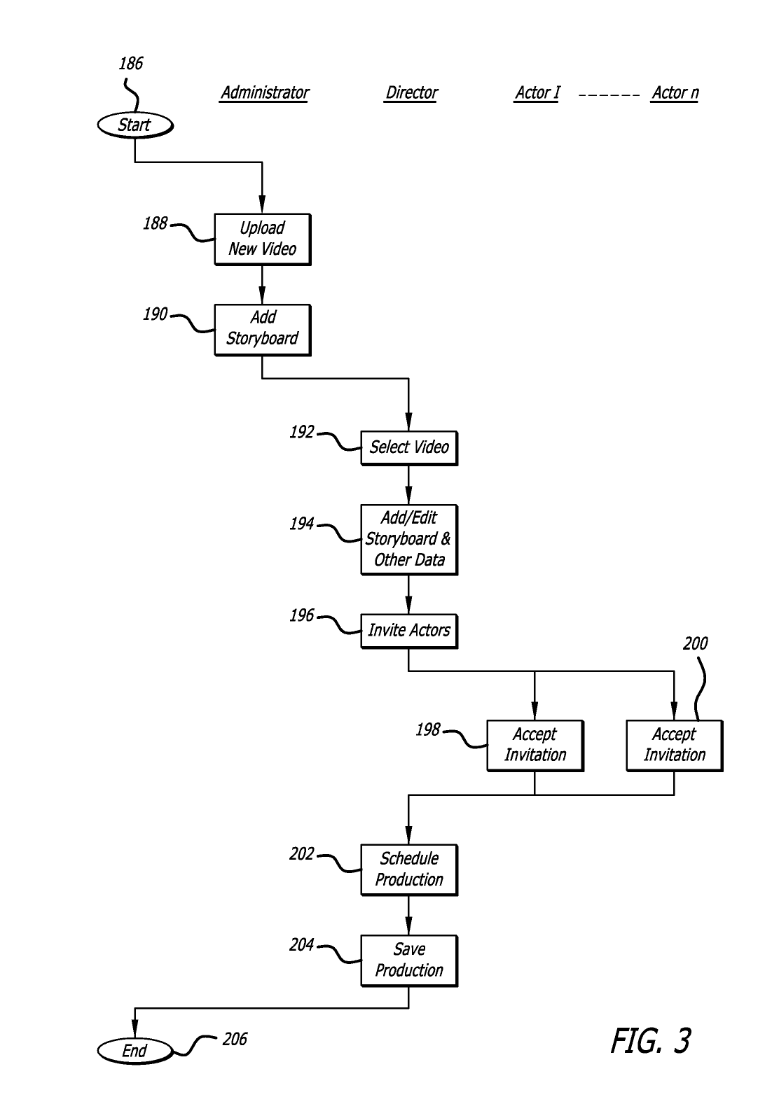

Turning now to FIG. 3, a flowchart depicting the steps of the process of the present invention are shown. In this Figure, each of the columns above indicate the individual or individuals performing the action. First, the process must begin in the start step 186. This process is initiated when the server 100 (see FIG. 2) begins operating and accepting the uploading of new videos.

During the start step 186, an administrator logs into the server 100 and begins the process of creating a new video clip for which audio may be created. The administrator in the preferred embodiment is one or more individuals responsible for uploading new videos and the storyboard or other metadata associated with the new video. In the preferred embodiment, only the administrator may perform this function. In alternative embodiments, users may be able to upload videos and to add or edit storyboards themselves.

In the first step of this process, the administrator uploads a new video in the upload video step 188. Generally, this video is a video clip for which the administrator, perhaps in conjunction with one or more writers, has created or intends to create a storyboard or which the administrator believes may be used to create humorous or interesting new combined audio and video. In other embodiments, users of the site may be able to upload their own videos.

In the next step, the administrator adds a storyboard to the video uploaded in the upload new video step 188. This is completed in the add storyboard step 190. In this step 190, the administrator creates storyboard information useful in creating new audio for the uploaded video clip. In the preferred embodiment, the metadata (or storyboard) includes but is not limited to a listing of each role within the clip, a gender associated with each role, start time and end time of each speaking (or other sound) part for each role (“cueing”), the length of the entire clip, a suggested “premise,” a suggested “trait” or “traits” and suggested “objective” or “objectives” for each role. During this step 190, all of this metadata associated with the video is created and added to the storyboard.

A suggested “premise” is a basic storyline of the clip and may including the time frame, the setting, the reason for the characters to be present, etc. A suggested “trait” is generally an irregularity or unusual aspect associated with a particular character. It is suggested, and typically hidden from each other participant, in order to aid in the creation of an interesting or humorous scenario. An “objective” is a goal or desire provided to each participant that is also suggested and typically hidden from each other participant. The premise, traits and objectives may be followed, ignored or modified.

Once the uploading step 188 and the add storyboard step 190 are complete, the director may select the video for use in creating new audio. In practice, the administrator will upload numerous videos to the server 100 (see FIG. 2) add storyboard and make the combined clip and storyboard available so that a director may choose it to create new audio. In the select video step 192, the director may select one of the uploaded videos for which to create new audio.

During the select video step 192, the director may have a particular video in mind and a particular story he or she would like to tell. Alternatively, the director may simply begin searching for or browsing through one of a number of pre-existing available videos on the site. Inspiration may strike the director as he views one or more available clips.

The director may search for a pre-existing video. Steps 188 and 190 are shown in order to fully describe the process. All pre-existing videos include a previously-created storyboard, created by the administrator. In embodiments in which user-uploaded videos are used, the storyboard must be created by a user.

Once the director has selected the clip 192 to be used in a new creation, the director may then add or amend the storyboard in the add/edit storyboard and other data step 194. In the case of a pre-existing clip, the storyboard may be altered such that it is different from the storyboard created by the administrator. The amended storyboard may provide for different “traits” or “objectives.” The storyboard may be edited to create a title for the new process and to input any other direction the director may have for the actors.

As described above, the storyboard also includes the timings of all speech and sound effects. The entire video clip for which sound is to be created may be represented as a timeline from a start time to an end time. At various points throughout the timeline of its running, one or more actors may speak for various durations. In some embodiments, a director may also amend, during step 194, the timing, location or duration of various roles in the timeline. However, in the preferred embodiment the director may not amend the timing, location and duration.

The storyboard is available to all actors taking part in a new game. However, some portions of the storyboard are may only be available only to one actor, for example, the “traits” and “objectives” for a particular role may only be available to the actor of a particular role in order to provide more spontaneity to the audio creation. The director may provide additional direction or no direction, verbally or via text message.

Next, the director may search for, find, select and invite actors in the invite actors step 196. In this step, the director uses the capabilities of the website or client software 130 to search for actors to take part in the game. First, the director generally considers the number of actors needed for the clip. This type of information is included in the storyboard for a clip. In most cases, the number of actors the game will include will mirror the number of actors in the original clip. In other cases, a director may wish to include a non-matching number of actors in a game.

Next, the director may consider the gender of the parts available. A director may wish to cast the clip as it was originally created, matching various actors genders. In other cases, the director may wish to intentionally miscast actors as opposite genders. In some instances, the storyboard itself may have originally directed the director to miscast one or more roles. A director may select actors to invite from within his or her address book, search for actors using any number of search criteria or request that specific actors take part by inputting their names into an invitation.

The director may consider any number of other factors including the actor's capability to perform particular roles, audition audio created by actors, the actor's prior work on other audio and video combinations, the director's prior experience working with an actor, a pre-existing friendship or other relationship with a given actor. Individuals may choose to work together for any number of reasons.

In alternative embodiments, the director may simply be matched with one or more actors who indicate that they are “ready to work” and are immediately online. The director may simply begin inviting contacts which he has previously worked with who appear in his address book. In some cases, directors may simply wish to take part in the creation of a game very quickly. In alternative embodiments, the present invention provides means by which a director may determine that certain actors are present and ready to act in whatever games a director is willing to cast them.

In alternative embodiments, a “play now” button or similar functionality may be provided whereby the director may be able to utilize the present invention to use the storyboard to cast a particular game automatically using the number of participants and genders of the participants indicated in the storyboard. The “play now” button immediately and automatically invites actors who have indicated they are “ready to work” at the moment the selection is made by a director. The “play now” algorithm may also consider associations of the director to the actor, prior work together or the number of “play now” audio and video combinations that have been “popular” as determined by various web-based metrics.

In the preferred embodiment, invitations to take part in a game are sent to a user by a director using the client software 130. If a user is currently using the client software 130, the user will receive an invitation immediately as a popup message via the text server 172 and text client 174. Alternatively, the voice server 170 and voice client 168 may be used to allow a director and actor to communicate vocally to determine if they are interested in working together. If a user is not currently using the client software 130, the user may receive an invitation via email or text message.

Once the director has selected the actors he or she wishes to take part in the game and sent the invitation to each actor, the actors are given an opportunity to respond. If the director and actor are currently simultaneously using their client software 130, the invitation and resulting responses may result in an on-going chat or voice-based interaction between the director and actor regarding the invitation. In the case that the actor is not currently using their client software 130, the user may respond with questions regarding the production, the director or other actors before accepting or declining the invitation to participate.

The actor may then accept the invitation to perform in the accept invitation step 198. As is common, most productions require more than a single actor. Of course, the director may be the sole actor, whereby no invitation is necessary. In these cases, the client application 130 will be in “stand alone” mode wherein a director may play each role.

However, in most cases, a multiplicity of actors are invited such that actors 1 through n may also accept the invitation to participate in the accept invitation step 200. It is to be understood that any number of actors may be invited and may accept or decline the invitation in the preferred embodiment.

One or more actors may not accept the invitation. In this case, the director is notified by the client software 130 that one or more actors have not accepted the invitation to perform. The director may then search for or use any other means provided to fill the remaining roles.

Once each of the actors taking part in the production have been invited and have accepted the invitation such that all desired roles have been filled, the director may schedule the production in the schedule production step 202. In this step, the director may be presented with an availability schedule for each actors. Times during which each of the actors has stated to be available for taking part in a game may be shown. In some embodiments, this functionality will not be available.

These schedules are based upon data input by the user using the My Calendar function described later and may be updated at any time. In other cases, communications may be sent through the client application 130 as a text message or via email until a time and date are agreed upon by some or all of the parties. All parties need not present during the recording. The director may then input the dates and times for recording.

The director may save the production in the save production step 204. In this step, all of the details pertaining to the production are saved such as the video clip to be used, the actors to take part, the current director of the production, the storyboard including any modifications to the storyboard and the schedule of recording. The process of scheduling a new audio recording session then completes in the end step 206.

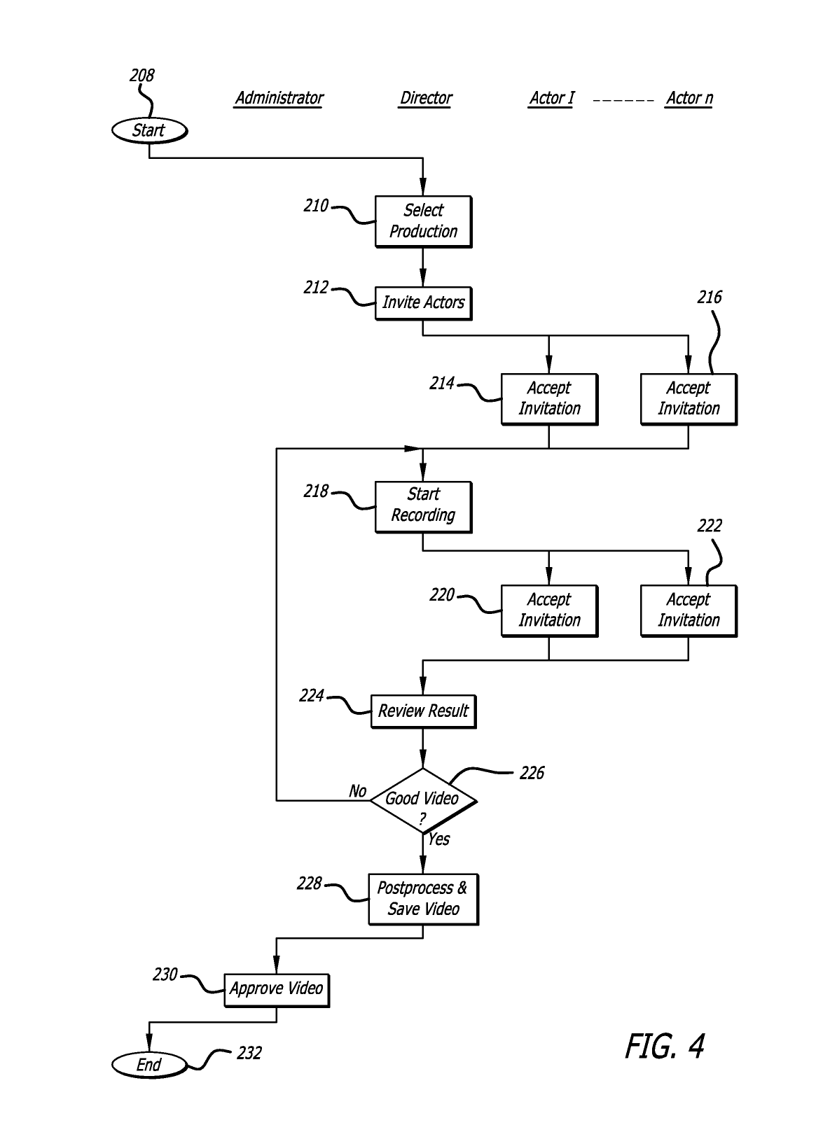

Referring now to FIG. 4, a depiction of the subsequent process of creating the combined audio and video is shown. As above with regard to FIG. 3, the titles above each column indicate the individual or individuals performing a specific step. The process must begin in the start step 208. This may begin when a director begins using the client software 130 or at a pre-scheduled time as discussed above.

Next, the director selects a production the select production step 210. The recording of the combined audio and video will based on this production. In this step 210, the director selects from one or more available productions. The director may select one of the productions in order to begin.

In the preferred embodiment of the present invention this step initiates the functionality of viewing video and creating, recording and storing audio which is installed on each of the director and actors computers, and launching communication capabilities to facilitate the collaborative recording session. In other embodiments, the software may be contained within the website itself. The director may then invite the actors to join in the audio dubbing session in the invite actors step 212.

Once the actors accept the invitation in actor accept invitation step 214 and actor accept invitation step 216, the recording of audio to overdub a track is ready to begin. As in previous figures, actor n is intended to represent any number of actors from actor number 1 to actor number n. After a user accepts the invitation, the process of recording the combined audio and video can begin.

The client software 130 begins working on each user's computer. In the preferred embodiment, the client software 130 has two modes, an “actor mode” and a “director mode.” In actor mode, the user is presented with a smaller subset of abilities than the user of the application in director mode.

Generally, the actor mode is capable of viewing the video clip for which audio will be created, viewing the storyboard in a number of ways, participating in voice and text communication with all other actors and the director and allowing the user to track the progress of the video clip in order to properly time his or her audio additions to the new combined audio and video.

In particular, the actor mode allows an actor to communicate with the other actors and the director in order to allow them to discuss the recording session, the voices, the inflection and the overall action involved in creating the new combined audio and video. This generally takes place using voice over internet protocol. The actor mode also allows the actor to view the scene as a timeline, to view other metadata such as the part they are playing, the traits and objectives in the storyboard and any director notes. The actor mode also allows the user to input their own comments or “notes” for use during the recording process that is to come.

The actor mode allows the actor to control the previewing of the video at the discretion of the director. In the preferred embodiment the ability of the actor to independently play the video ceases and comes solely under the director's control once the recording session has been initiated. It does not allow the actor to select which other users are playing which part or to begin the recording process. It does not allow the actor to edit the storyboard, though, in some embodiments it may or the director may be able to enable the capability of one or more actors to edit a storyboard.

The director mode provides substantially more control to a user who is currently designated as the director. In alternative embodiments, the director may allow other users to be directors or empower them with some of the director capability or the “director” title may be given to another user if the current director so desires.

The director mode provides all of the capabilities of the actor mode described above but also provides additional capabilities. In the director mode, the video clip for which a new audio track is being created, is always under the control of the director. For example, the director may stop recording, rewind the clip, fast forward the clip, jump to the front or end of the clip or jump to a particular actor's line at any time.

As above, the director is presented with the storyboard for the clip in both textual and time-line form (see FIG. 9). In the preferred embodiment, the director may edit the storyboard at will. As the storyboard is edited, the changed contents are sent immediately to all current actors. This allows the director to provide more detailed direction as the recording process is going forward.

The director mode allows the director to control the recording process. The director may start the recording from the beginning of the clip and record until end the end of the clip or start from anywhere and stop anywhere. The director may return to a particular actor's part, to a particular location to re-record or to delete or otherwise amend a portion of audio. Of course, as audio is recorded and as the process goes forward, all audio is simultaneously sent to all other actors and the director. The director mode also provides for post-processing of the videos once the recording is complete. This is described in greater detail below.

The recording begins in the start recording step 218. In this step, the director selects a button in the director mode of the client application 130 to begin the recording session. Typically, this occurs after the director and actors have had several minutes in which to communicate, using the voice client 168 and voice server 170, or text messaging using the text client 174 and text server 172 about the game. In the preferred embodiment of the present invention, all of the actors are logged into the site, have accepted the invitation to begin and have begun recording. In the preferred embodiment, the recording takes place in real-time. In other embodiments, the recording by each actor may take place asynchronously.

In the preferred embodiment, as described above, separate web-enabled software is launched on each actor's computer along with the director mode of the web-enabled software launching on the director's computer. This software enables the creation and review of new audio that will be added to the selected video clip. In the preferred embodiment, this web-enabled software takes the form of the client software 130 above. In order to synchronize the actor's voices with the video, the video is played without sound on the software while the actors each voice their appropriate parts.

This process takes place, substantially, in real-time as each actor voices their appropriate parts while viewing the video in real-time and reacting to the inputs of the other actors. All actors hear the other actors' performance real-time via VoIP. Simultaneously, the client software 130 records the user's audio using the audio recorder 152. The audio may then be compressed using the audio encoder 154 and sent to the server 100 and to other clients 104 using a protocol such as FTP. In some embodiments, the audio is not first compressed. In these embodiments, the server will compress the audio once it arrives or the audio will be automatically compressed as it is recorded.

In the preferred embodiment, as each audio portion is completed by a client, the audio portion is compressed, sent to the server 100 and a notification is sent to the message server 164 within the server software 128 that the audio portion is completed. The message client 166 associated with each other user is then notified that an audio portion for one user is complete and available on the server. Then the client software 130 associated with each user requests and receives the audio file created by each other client in substantially real-time, such that they may replay the audio immediately upon completion of the recording. In alternative embodiments, the audio will be sent directly from client to client in a peer-to-peer fashion.

This process is completed by each actor in the actor perform scene step 220 and the actor perform scene step 222. As each actor records his or her audio portion, it is incorporated into a whole for use in creating an entire audio and video combination. The audio files created by each actor are simultaneously distributed to all other actors and the director (who may simultaneously be an actor as well). In this way, the actors are able to hear and view the resulting creation when recording has ceased. However, the director maintains control over the recording process until it is complete.

As this process is occurring the client software 130 may work in alternative embodiments to intelligently edit the created audio. For example, the client software 130 may utilize the timeline present in the metadata associated with a particular clip to intentionally ignore audio created by one or more actors during a time in which the particular actor is not on cue to speak. This can help to eliminate unnecessary extraneous sounds created by that actor.

The client software 130 may act to determine a baseline of audio for a given actor. This baseline will enable the audio portion for each actor to be equalized. As is known in the art, recording audio at different locations may result in unevenness amongst the actors in terms of background noise. In some locations there is a great deal of background noise, in others it is relatively silent. The client software 130 may also perform voice cleanup functions such as echo cancellation or echo suppression or reverb suppression or noise reduction in order enhance the quality of the recording experience.

The client software 130 may determine a baseline for one client 104 and utilize that baseline in order to determine when an actor is speaking and when the actor is not. This is sometimes called automatic voice detection and may include adjustable threshold detection. Similarly, the server software may be capable of utilizing a sum of these audio baselines in order to adjust volume levels on the several audio clips making up the entire audio portion of the new combined audio and video such that the resulting audio track sounds as though it were created in a single location or sound stage without distortion. This is known as intelligent audio equalization.

In some embodiments, the client software 130 at each client 104 or at a particular client 104, such as the director, may also edit, amend, move or cut down part or all of an audio track created by one actor down only to those portions wherein the actor was speaking within the pre-determined cue-times. In this alternative way, extraneous noises created when the actor was not speaking may be eliminated.

In the preferred embodiment, the present invention records audio locally, then transmits it, as quickly as possible, to other client software 130. This results in no latency issues while recording audio. However, in alternative embodiments in which audio for all participants is recorded on one client 104 latency may affect the recording process. If an actor speaks, but slightly off-cue, for example due to latency amongst client applications, the server may adjust the spoken portion of a given actor's part such that it fits within the appropriate cue based upon the storyboard timeline.

Once all the audio portions have been created, recorded, transmitted to the server and downloaded by each client software 130, the director and all actors may view the resulting video in the review result step 224. The director may review the resulting audio and video creation alone or in concert with the accompanying actors. In this step, the audio is combined on each user computer for viewing so that subject allowance by the director they may review it themselves outside of the control of the director.

The resulting combined audio and video may be played, paused, stopped, fast forwarded, rewound and restarted. During the review result step 224, if the director finds the audio and video combination to be satisfactory, he or she may indicate as much in the good video step 226.

If the director is not satisfied with the resulting combined audio and video, the director may request that one or more actors re-record their parts. In alternative embodiments, the director may request that all participants re-record their parts. If this is the case, the process begins again at the start recording step 218. However, the director may return precisely to a single portion of the audio for rerecording by one or more actors.

At this point, the director may request that one or more actors re-record their parts. Using the director mode of the client software 130, the director may return the video clip to immediately before a given actor's cue. The director then may discuss any issues that he or she had with the actor's performance using either voice over internet protocol or textual messaging as enabled by the client software 130.

The director may then request that the actor re-record a role. As he or she requests the re-recording, the director begins the recording process, using the director mode. The director may indicate to the software that he or she wishes only to re-record a single part by clicking on that part in the timeline. Alternatively, the director may delete the previously-recorded part by clicking on it with his or her mouse and choosing the delete function. Once the part is deleted, the director may request re-recording which is transmitted to the particular actor's client application. The application then allows the client to re-record the audio portion.

Once each part of the production is complete, the director indicates as such using the director mode of the client software 130. The director may then perform postprocessing on the newly created combined audio and video file before it is uploaded to the server 100 for sharing. This postproduction on the resulting combined audio and video file occurs in the postprocess and save video step 228. This step occurs within the client software 130 on the computer of the individual acting as the director.

The audio and video file may have various postprocessing effects applied. In the most basic postprocessing, the director may slightly adjust the timings of various actors speaking, shorten or lengthen it slightly or add sound effects. Additionally, in some embodiments, blur effects, starbursts, transitions from scene to scene, titles, subtitles, slowing and speeding of frames and various other “postproduction” effects may be applied in the postprocess and save video step 228 by the director.

Once all postprocessing is complete, the video is encoded, using the video encoder 150 (see FIG. 2) of the director's client software 130 and is sent to the server 100 and stored in the video file repository 116 for later viewing by a viewer 108. The resulting video is a new creation made up of the new audio created by one or more actors and the original video either uploaded by a user or previously resident on the server 100 (see FIG. 1). This video may then be made available on a website or stored locally for viewing or transmission later as a user desires. This is the end of the process as shown in the end step 284.

In the preferred embodiment, the combined audio and video is created by a user of the client software 130 acting as the director. The audio is gathered by the director's client software 130, encoded into the video then uploaded to the video file repository 116. As described above, the audio files used to create the combined audio and video are uploaded to the server 100 simultaneously with their transmission to each other user's client software 130. In alternative embodiments, the audio may be combined at the server 100 by the server software 128. In these embodiments, higher resolution videos may be created or higher-quality audio may be used.

Turning now to FIG. 5, a startup screen 234 of an example client software 130 of the preferred embodiment is shown. It is to be expressly understood that this client software 130 may take many forms and that this depiction is only an example. In the preferred embodiment, the client software 130 is a stand-alone application capable of communicating with the server software 128 and other client software 130 taking part in the creation of the combined audio and video. In alternative embodiments, the client software may be integrated into a web site usable by a browser or may include additional or less functionality than is shown in the following figures.

In the preferred embodiment, the startup screen 234 of the client software 130 running on a user's computer includes a menu bar and a web browser. The menu bar in this representation appears along the left side of the screen and enables many of the functions of the present invention. The web browser may be seen in the center of the screen and, in the preferred embodiment, begins by showing a web page associated with the client software 130.

The go to soundstage button 244 takes the director immediately to the “soundstage” form of the client software 130 wherein a director is given control over the creation of the recording session and wherein upon the director alone or with other actors who have accepted an invitation are able to view and record, at the direction of the director, audio for a given video clip. This button 244 may be used for previously-scheduled sessions or recently agreed upon sessions or stand alone sessions.

Selecting the my calendar button 246 allows a user to view his or her calendar. A user may input dates or times in which he or she is available for the creation of a new combined audio and video. The calendar also shows upcoming productions which are already scheduled for creation.

Selecting the my user info button 248 allows a user to edit details such as username, password and any other more private information which a user may or may not wish for other users to see. The contact window button 250 brings up a window including all contacts which have accepted a user's invitation to join his or her “address book.” The user may see, in real time, whether these contacts are currently online or if they are not available. Selecting one of those users allows the user to send a text message or contact by voice (VOIP) via the server 100 to one of those users.

The exit button 252 allows a user to exit the client software 130. This button closes the client software 130 and in the preferred embodiment, logs the user out of the server 100 such that the user no longer appears to be “online” to his or her contacts. In alternative embodiments, this button 252 may simply minimize the client software 130 while allowing the user to remain available or allow the user to post an availability status to the community.

An example main page which may be used as a portion of the startup screen 234 is shown in FIG. 5. This main page is also available to registered individuals who have not yet used the client software 130, but who wish to simply view combined audio and video. First, the main page includes tabs inside the browser window. These tabs, such as the view rideos tab 254, the actor's portfolio tab 256, the director's notebook tab 258 and the rideo community tab 260 provide views which may be used to accomplish different tasks.

A user may click on a tab, such as the view rideos tab 254 in order to be presented with a page used for viewing one or more audio and video combinations.

A user may select the actor's portfolio tab 256 in order to view a user's information and profile. Upon selection of the actor's portfolio tab 256, a user may search for or browser the database to view other user's portfolios or may choose to view and or edit their own profile if they are logged into the site. If editing their own a user may upload (or create) audition audio files, for example, creating a file of various impressions or a description of the type of work a given actor would like to perform.

The actor may also upload an image, input personal information, input any number of details related to work they would like to perform and similar information. The actor's portfolio may be viewed by potential directors seeking to select an actor for a role in a new combined audio and video, so actors may be encouraged to input more or less detail dependent upon their preferences. Because users may take on many roles during the creation of a combined audio and video, the profile is suitably broad to encompass all relevant information.

A user may select the director's notebook tab 258 which provides a summary of upcoming productions. The director's notebook tab 258 allows a director to begin the process of creating a production or to resume the creation of a new production and editing it. Finally, the rideo community tab 260 allows a user to find and interact with other users for future creations.

Various links 262 are also provided such as sign up, login, account, support, download and about us. These are common in the art and, therefore, are not explained in detail. Their form and function generally follow methods and systems known in the art. Similarly, a sign up field 264, as is known in the art, is provided whereby a user may login to the site.

Turning now to the portion of the view rideos tab 254 which allows users to preview a particular combined audio and video file, the title filtering 266 is shown. The title 270 for this example combined audio and video creation is “Never Buy Botox in Burbank.” As can be seen, each of the combined audio and video creations has a title.

A number of tags 266 may be used to allow a user to find combined audio and video of a certain type. Time frame filtering 268 may also be used. In some instances, a search field 302 may be used to find combined audio and video by a particular actor, director, title or other related data. The search field 302 is described in greater detail below.

With regard to a particular combined audio and video that is being displayed, a viewer rating 274 may also be displayed. The viewer rating 274 is entered by users which are logged into the site as they view the video. An excellent viewer rating 274 may result in the combined audio and video file being added to a popular group or to a group such as rideo gems which may be displayed automatically as a first group of combined audio and video files that a user sees upon logging into the site.

The number of times the combined audio and video file has been viewed can also be seen in the times viewed indicator 276. Similarly, the date posted indicator 278 may be seen in order to determine how long the combined audio and video has been available on the web site. Additional data about the video may be provided. In the preferred embodiment, this information is stored in a database on the server 100.

The cast 280 of the audio portion is also displayed in the preferred embodiment. Various users may become well-known for providing excellent audio, funny audio or for performing particular impressions. The cast 280 is listed by part, for example the nurse 282 is shown as the cast username 284 “Shannon C.” In general the cast is identified by cast username 284 instead of actual name in order to provide a level of privacy as to the user's true identity.

The director 286 may also be seen. In this case the director username 288 “Dr.Wonderful.” A director commentary 290 may also be provided. A director may provide a written or audio or audio-video commentary for the work that has been created using the process described with reference to later figures.

There are other combined audio and video files suitable for viewing displayed in this main page within the startup screen 234 including display of storyboard used in creating the combined audio and video. The title 292 of another combined audio and video may be seen along with the title 294. Various genre tags 296, rideo picks tags 298 and popular tags 300, based upon user selection may also be seen and browsed by a user.

The search 302 may be used to search for combined audio and video. Keyword searches may be performed based on audio and video title, actors' usernames, director's usernames, the description of the video, storyboard information, user ratings, any information contained in the video tags, the number of roles available in a given video, the number of roles for males or females in a given video and for various other attributes of videos or combined audio and video.

The user profile in the portfolio tab 256 includes a picture, a gender description, a listing of other productions the user has taken part in as a director or as an actor, a listing of personal goals, a stored group of audition audio or audio and, in some embodiments, video files, a listing of skills the user has (such as impressions) and contains an indication of whether the user is currently using the client software 130.

This profile is similar to profiles known in the prior art, however, it has several unique attributes. The listing of personal goals indicate projects or types of projects upon which a user would like to work. This is a section unique to the present invention. Similarly, the profile information pertaining to skill tags is not known in the prior art. Other social networking sites or video sharing sites are not typically interested in character impressions, singing talent or the ability to storyboard a scene that a user may or may not posses.

Similarly, other social networking or video sharing sites are not interested in performing auditions or tracking auditions. In the preferred embodiment the audition takes the form of a stored audio clip of the user. In alternative embodiments, audio and video auditions may be provided. The audition may demonstrate a particular skill, impression or type of work. The audition may only be an introduction to the individual or a description of prior projects.

A potential director, seeking to add a user to a new production, may select the director's notebook button 238 and begin to review one or more auditions. For example, a director may search for an impression of a particular actor. The director may then be presented with a vast number of potential actors who suggest that they are capable of that impression. The director may then view the actor's portfolio and see that there are auditions of the actor's impression. The director may listen to a few additional actors auditions and then select the one most suitable for a particular game.

Users may also view each other's profiles, for example, with the intent to create a new audio and video combination. Users may find other users using the system of this invention in a number of ways. Users may search for others using any of the data contained in any user's profile. Users may click on a username, such as cast username 284 in FIG. 5 in order to view that user's profile and to, potentially, request that the user take part in a new game. If the user is online currently, the user will receive a notification immediately via the website notification system using the message server 162 (see FIG. 2). If the user is not currently online, then the user will receive an email or text message notification.

Within the client software 130, a user can request that a user be added to a group of friends or is otherwise inserted into a list of known contacts. In the preferred embodiment, this is called the address book, as discussed with reference to the contact window button 250. In the preferred embodiment, users must request that other users allow them to be inserted into their address book. This is done in order to ensure that users are aware that they are in one another's address book. Users in each other's address book may communicate more directly than other users. For example, users receive indications that individuals in their address book are currently online in real-time.

The director's notebook tab 258 may be selected to initiate the process of creating a new production or to edit an existing production. As described above the word “production” defines the project. It is analogous to a movie project where the script, actors, location, shoot schedule, etc define the project prior to the actual filming. In this case the “production” includes at least the clip, the storyboard and the actors. Users take part in a production to create the dubbed audio for a specific video clip.

The director's notebook tab 258 provides access to the functionality to create and/or edit a production. As described above, an example timeline as used as a portion of the metadata included in or along-with a given video file is shown in FIG. 9. This visual representation is not intended to be an actual representation of the contents of the metadata, but is a representation of the cues, parts and timeline of the actors in the video as it will be created by a group of actors.

The system and method of the present invention may be further understood with reference to several example figures depicting the process visually as it takes place in the preferred embodiment. It is to be expressly understood that these depictions are not intended to be limiting, but to be illustrative. Other embodiments of the present invention are possible.

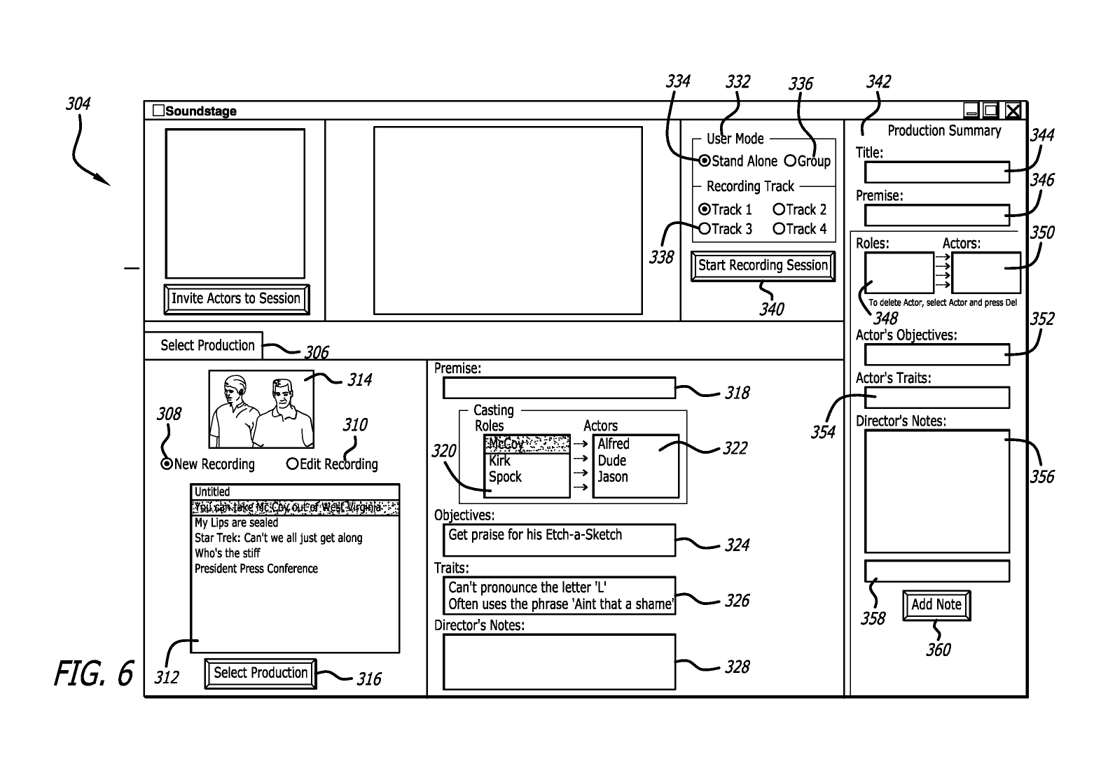

FIG. 6 is a depiction of the soundstage 304 of the client software 130. This mode appears to a user, in this case the director, after selecting the go to soundstage button 244 (see FIG. 5). A user of the soundstage 304 is first presented with the opportunity to select a production 306. This allows a director to select the production for which the recording session will create audio.

The user may select whether or not to create a new recording 308 or to edit an existing recording 310. The user, acting as the director in this case, may select from one of many productions available in the selection box 312. A preview of the production is shown in the preview window 314. To help with the selection the user is presented with a summary of the selected production. This is information (shown in elements 318, 320, 322, 324, 326 and 328) created in the production process in the director's notebook. The director may choose to go back and edit the production information at this point. Once the user has made his or her selection, the user selects the select production button 316. This step corresponds to the select production step 210 in FIG. 4. In the process of creating the new combined audio and video, additional choices must be made. The director may use the user mode pane 332 to select stand alone mode 334 wherein a director may fulfill all roles alone or group mode 336 whereby a group of individuals may take part in the recording process.

The director may use the recording track pane 338, to select which track is to be recorded during the recording process, while in stand-alone mode. The start recording session button 340 is used once all actors have joined the session. The button toggles to allow the director to start or stop the recording session. While in the recording session, only the director can control the video clip.

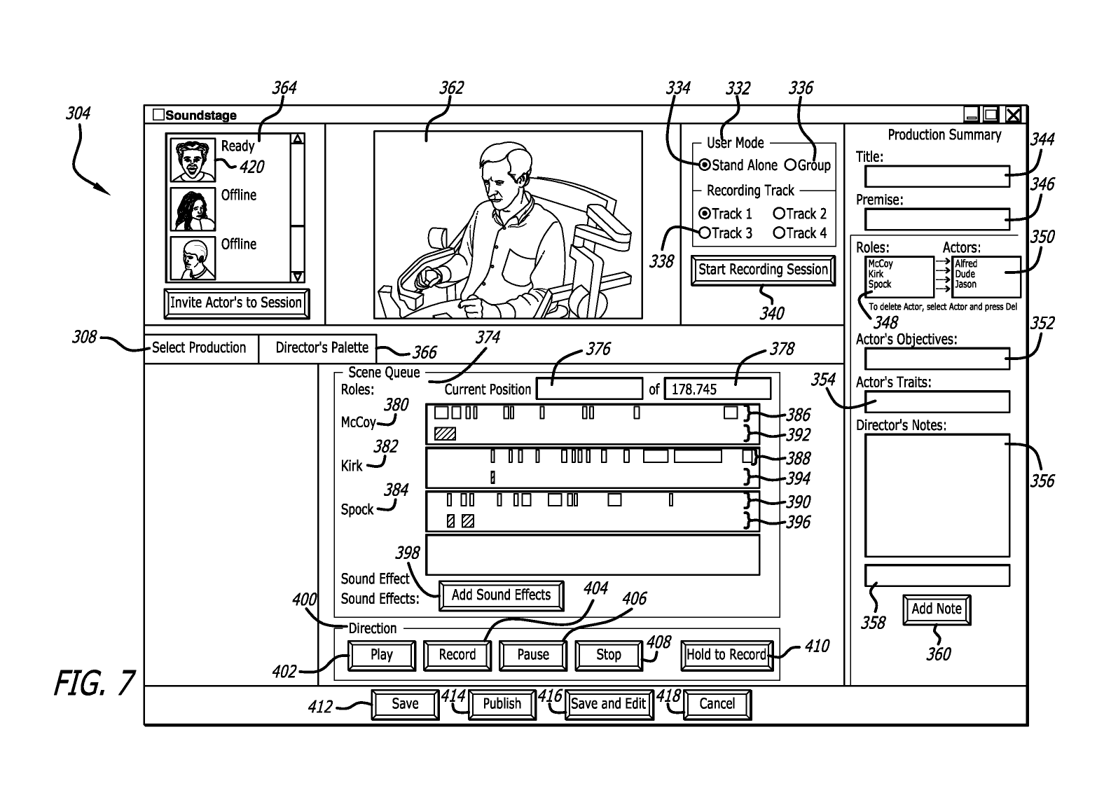

The production summary 342 details information for the production and is predominantly for reference purposes. It includes the title box 344, the premise box 346, the roles box 348, actors box 350, the actor's objectives box 352, actor's traits box 354 and director's notes box 356. The director's notes box 356 will be filled in with anything added by the director or previously created by the administrator. The actor may add notes to the director's notes, once production has begun, using the add note box 358 and the add note button 360. Similarly, the video display 362 will be loaded with the video clip once the production has been selected. Additional understanding may be had with reference to FIG. 7. FIG. 7 is a view of the soundstage 304 that is provided only to a director. While the client software 130 is capable of acting both as a director and as an actor, as described above, while acting as a director, additional functionality is available. While acting as an actor, the client software 130 prohibits control, for example, of the recording process. The view of FIG. 7 is of the director acting in the midst of the recording process.

FIG. 7 is illustrative of the condition once a director has selected a production and can now start the recording session or pick the select production tab to chose a different production. The director's palette 366 is typically displayed in the recording process. The actors which are to take part are, therefore, usually already known. The actor status box 364 includes the listing of actors included in the production. It provides the director with a real time status of each actor involved in the production. Actor status includes, as example, but is not limited to “online”, “offline”, “ready”, “playing video”, “buffering” and other similar status messages. It is unique to this application and key informational element in helping the director manage the recording session.

The scene cue 374 shows the timeline of the scene to be taking place. The timeline includes the current position 376 (in seconds) and the total time 378 (in seconds) of the clip. As recording takes place, a vertical line will move across the screen as a visual indicator of the current position along the timeline. The time line may be moved by a mouse so that is easy for the director to pick specific points to start recording.

The roles, such as McCoy 380, Kirk 382 and Spock 384 are shown along the left side of the scene cue 374. These roles are already associated with particular actors. Importantly, the administrator has input into the storyboard, in addition to the traits, objectives and premise discussed above, the beginning time and end time of each time a given role is speaking. These are visually represented in the timeline.

For example, McCoy 380 speaks each time there is a darkened box along the timeline 386. Kirk 382 speaks each time there is a lighter grey box along the timeline 388 while Spock speaks while there is a darker grey box along the timeline 390. After each actor speaks their roles, the times and lengths of each actor's speaking is represented along the timelines 392, 394 and 396 appearing immediately below each actor's role as can be seen

The director may add sound effects using the add sound effect button 398. Importantly, the director, and the director only, may use the direction pane 400. The director may play the clip using the play button 402 or begin recording using the record button 404. The director may pause or stop the process using the pause button 406 or the stop button 408. Each actor and the director (who typically takes one of the parts) may record their voice using the hold to record button 410 when recording is on-going. The video display 362 shows the video as controlled by the director.

In other embodiments, the client software 130 may automatically detect when the actor is speaking, and the hold to record button 410 is not needed. In other embodiments, the client software may record continuously, and neither the hold to record button 410 nor automatic detection is needed.

As with FIG. 6, the user mode pane 332 may be used to select stand alone mode 334 or group mode 336. In stand alone mode 334 the director acts each part, in group mode 336 the director has assigned parts to various actors. As stand alone mode 334 is currently selected, the director may select which track to currently record using the recording track pane 338. When the director is ready, the director may select the start recording session button 340.

Certain fields of the production summary 342 may be filled in by the director at any time. Typically these fields will be highlighted indicating that they are editable. The title box 344, premise box 346, roles box 348, actors box 350, actor's objectives box 352, actor's traits box 354 and the directors notes box 356 are examples of such fields. As described above, directors notes may be added using the add note box 358 and the add note button 360. Before recording participating actors who are online need to be invited and accept an invitation. Upon acceptance they receive the actor's production information and initiate the process of downloading it. Upon acceptance of the invitation to participate the actor's status box 364 shows the progress of the actor's downloading process so that the director may know when everyone is ready. The director invites the actors to the session using the invite actors to session button 422. This corresponds to the invite actors step 212 in FIG. 4.

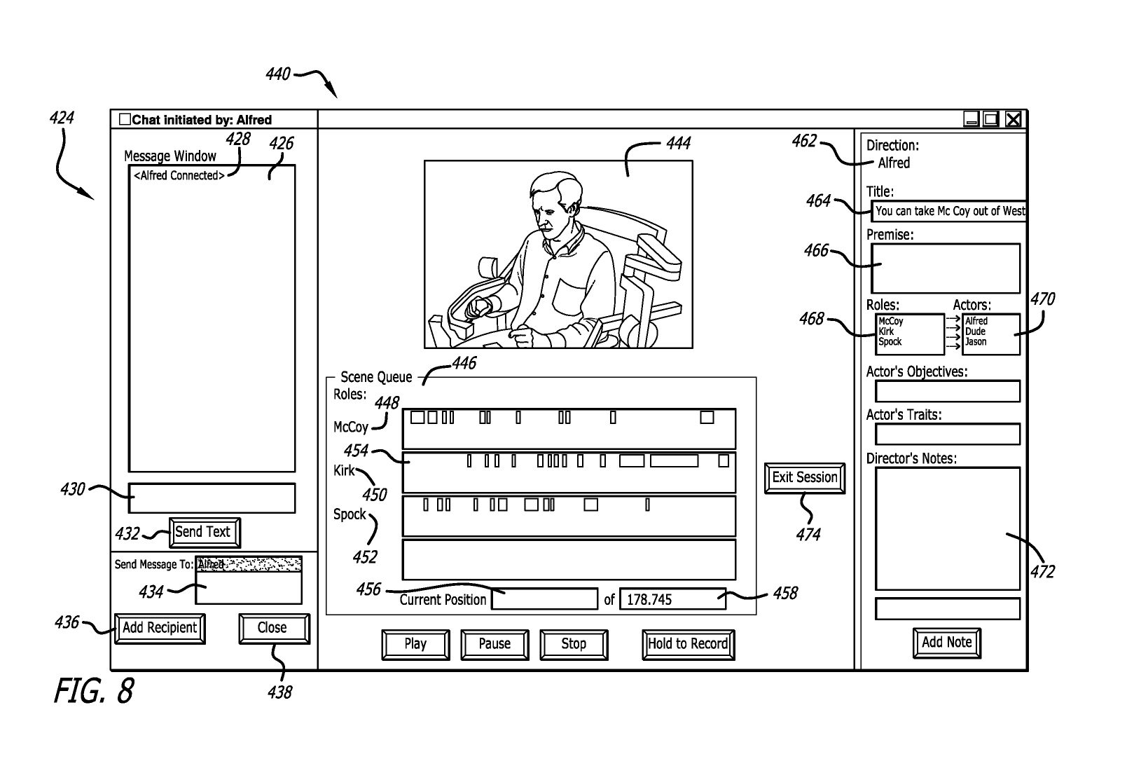

FIG. 8 shows the view provided to an actor. A chat pane 424 may be seen in the left-hand side of FIG. 8. The chat pane includes a message window 426 and any status information 428. The user may input any text he or she wishes to communicate to a user in the chat box 430 and select the send text button 432 to send the text to one individual or all users. The send message to box 434 indicates the users to which the text will be sent. The add recipient button 436 may be used to add additional users to the text session and the close button 438 may be used to close the chat.

Also visible in this view are the differences between the director mode and actor mode of the client software 130. The actor mode provides primarily non-editable information that is otherwise editable or alterable by the director in the director mode. The scene cue 446 provides the roles available and their timings, but is a non-editable pane. McCoy 448, Kirk 450 and Spock 452 are visible, but not selectable or alterable and the roles assigned are also unable to be changed. The current position box 456 and total time box 458 are provided as in the director view.

The production summary information, items 462, 464, 466, 468, 470 and 472, is the same as in the director mode except not editable. Finally an actor may simply exit the session by selecting the exit session button 474. This closes the actor's form 440 of the client application 130 and returns the user to the main page.

FIG. 9 generally shows an example timeline, including multiple roles, for use in creating a new audio portion for a given selection of video. These timelines are also seen in FIGS. 6 through 8. The start time 476 is shown as a vertical bar indicating that it is the beginning of the video clip. The end time 478 is also shown as a vertical bar. Between the start time 476 and the end time 478 all action for the video clip takes place.

The various roles are also shown in this figure. For example, role 1 is shown in element 480, role 2 is shown in element 482, role 3 is shown in element 484 and role 4 is shown in element 486. A horizontal line in the timeline corresponds to each of these roles, such as line 488.

On these lines, the portions of time during which a given actor is intended to speak are shown as blocks. For example, block 490 is shown. During the time represented by block 490, it is intended that a particular actor, in this case role 1 480, should speak. Block 498 indicates that it is intended that a different actor speak in that it is on a different line.

It is to be understood that a director and actor may both view the metadata associated with a particular video clip and game. However, the director is provided additional functionality before and after the recording process, for example during the postprocess and save video step 228 (see FIG. 4) and during the recording process itself.

The director may click upon a particular block (indicating a time during which an actor should speak), such as block 500 and is allowed to adjust the beginning time 502 and end time 504 of the part. This allows the director to adjust to more closely resemble the time of the speaking part on the screen for any reason the director so desires.

Similarly, the director may adjust the center point 508 for a given block, such as block 506. Adjusting the center point 508 allows a director to move the time at which an actor begins speaking and ends speaking without adjusting the total time the actor is speaking. This may be used if an actor was somewhat late or early in delivering lines, such that the on-screen lips match more closely with the new audio created.

Additional parts may occur along the timelines as are also indicated by additional blocks, such as block 510 and block 512. There may be any number of blocks, each associated with a speaking or sound-effect part, for any number of roles. The timeline is created with reference to metadata stored along with or within a video clip and may be used or referred to by the director and actors in the process of making a new audio portion for a given video clip.

Accordingly, an interactive multimedia game including audio dubbing of video has been described. It is to be understood that the foregoing description has been made with respect to specific embodiments thereof for illustrative purposes only. The overall spirit and scope of the present invention is limited only by the following claims, as defined in the foregoing description.

1. A computer-implemented system for collaborative interactive audio dubbing of video comprising:
a server, including:
a. server storage repository for storing video, audio and data;
b. server transmission means for transmitting said video, audio and data to a client;
d. server reception means for receiving said video, audio and data from said client;
e. server video encoding software for use in adding said audio to said video to thereby create a new combined audio and video; and
a client, including:
a. client storage repository for storing said video, audio and data;
b. client reception means for receiving said audio, video and data from said server;
c. client audio recording software for recording new audio for synchronization with said video
d. client video encoding software for use in adding said new audio to said video to thereby create a new combined audio and video; and
e. client transmission means for sending said new combined audio and video to said server.

2. The system of claim 1 wherein said server further includes client coordination software suitable for use in coordinating multiple clients as each of said multiple clients create and transmit one or more audio files to said multiple clients so that they may be heard and for combination into said new combined audio and video.

3. The system of claim 1 further comprising a viewer, including:
a. viewer reception means for receiving said new combined audio and video;
b. viewing software for use in viewing said new combined audio and video;
c. display means for use in viewing said new combined audio and video;

4. The system of claim 3, wherein said viewing software is a web browser.

5. The system of claim 3, wherein said server transmission means, server reception means, client transmission means, client reception means and viewer reception means each include the internet.

6. The system of claim 1, wherein said client further comprises:
a. a web client, suitable for requesting and receiving said data from a web server;
b. a logic engine, suitable for controlling all of the activities of the client;
c. audio compression client, suitable for compressing audio before it is transmitted; and
d. a video decoder, suitable for viewing said said combined audio and video.

7. The system of claim 2, wherein said server further comprises:
a. a logic engine, suitable for controlling all of the activities of the server;
b. communication server means whereby each of said multiple clients may communicate one with another; and wherein said server transmission means includes a web server suitable for transmitting said audio, video and data to said multiple clients.

8. A computer-based method for group creation of new audio for a selected video file comprising the steps of:
selecting a video file for which new audio will be created;
using a network to invite a first actor to take part in the creation of said new audio, wherein said first actor is at a location remote from the director;
receiving acceptance, via said network, of an invitation from said first actor;
scheduling the creation of said new audio; and
storing data related to said video file, said first actor and a schedule on a server.

9. The computer-based method of claim 8 further comprising the additional steps, immediately preceding the selecting a video step, of:
uploading said video file to a server; and
creating a new storyboard and a data file for said video file.

10. The computer-based method of claim 8 further comprising the additional step of editing a storyboard for said video file, wherein said editing step immediately follows the selecting a video file step.

11. The computer-based method of claim 8 further comprising the additional steps, preceding the using the network step, of:
searching for a first actor to take part in the creation of new audio for said video file; and
communicating with said first actor regarding the creation of new audio for said video file.

12. The computer-based method of claim 8, further comprising the additional steps, preceding the using a network step, of:
allowing the creation of an audition by a user in the form of an audio or video file;
storing said audition;
receiving a request for a said audition created by said first actor; and
providing access to said audition to a user.

13. The computer-based method of claim 8 further comprising the additional steps, following the using a network step, of:
using said network to invite a second actor to take part in the creation of said new audio, wherein said second actor is at a location remote from said first actor and said director.

14. A computer-based method for group creation of new audio asynchronously or in substantially real-time for a selected video comprising the steps of:
selecting a video for which new audio will be created;
inviting a first actor to take part in the recording of said new audio;
receiving an acceptance from said first actor to take part in the recording of said new audio;
recording said new audio as it is created; and
combining said new audio with said video to thereby create a new combined audio and video.

15. The computer-based method of claim 14, further comprising the additional steps of:
inviting a second actor to take part in the recording of said new audio; and
receiving an acceptance from said second actor to take part in the recording of said new audio.

16. The computer-based method of claim 15, wherein said first actor and said second actor are at locations remote from one another and from a director and wherein said first actor, said second actor and said director interact utilizing software-based communications means.

17. The computer-based method of claim 14 further comprising the additional steps of:
reviewing said new combined audio and video;
performing post-processing actions upon said new combined audio and video; and
approving said new combined audio and video.

18. The computer-based method of claim 17 further comprising the additional step of providing said new combined audio and video to a viewer for viewing.

19. The computer-based method of claim 17 further comprising the additional step, immediately following said reviewing step, of re-recording a portion of said new audio.
